(19) United States
(12) Patent Application Publication
(10) Pub. No.: US 2012/0177989 A1
(43) Pub. Date: Jul. 12, 2012

(54) NEGATIVE ACTIVE MATERIAL COMPOSITION, METHOD OF PREPARING NEGATIVE ELECTRODE PLATE BY USING NEGATIVE ACTIVE MATERIAL COMPOSITION, AND LITHIUM SECONDARY BATTERY MANUFACTURED BY USING THE NEGATIVE ACTIVE MATERIAL COMPOSITION

(76) Inventors: Dong-Ho Son, Yongin-si (KR); Ki-Jun Kim, Yongin-si (KR); Ihn Kim, Yongin-si (KR); Young-Su Kim, Yongin-si (KR); Sam-Jin Park, Yongin-si (KR); Na-Ri Seo, Yongin-si (KR); Myoung-Sun Kim, Yongin-si (KR)

(21) Appl. No.: 13/108,819

(22) Filed: May 16, 2011

Related U.S. Application Data
(60) Provisional application No. 61/432,156, filed on Jan. 12, 2011.

(51) Int. Cl. H01M 4/13; H01M 4/62; H01M 4/139

(52) U.S. Cl. 429/209; 29/623.5; 29/623.1; 252/182.1

(57) ABSTRACT

A negative active material composition includes a negative active material, a binder, and a solvent, in which the solvent includes an aqueous solvent and an organic solvent. A method of preparing a negative electrode plate uses the negative active material composition. A lithium battery is manufactured using the negative active material composition, and has good lifetime characteristics due to the formation of pores in the electrode plate.

### CROSS-REFERENCE TO RELATED APPLICATION

This application claims priority to and the benefit of U.S. Provisional Patent Application No. 61/432,156, filed on Jan. 12, 2011, the entire content of which is incorporated herein by reference

### BACKGROUND

1. Field of the Invention

The present invention relates to negative active material compositions, to methods of preparing negative electrode plates using the negative active material compositions, and to lithium secondary batteries manufactured using the negative active material compositions.

2. Description of Related Art

Recent advancements in and increasing demand for mobile devices have led to a high demand for secondary batteries as energy sources. Among secondary batteries, lithium secondary batteries having high energy density and high voltage are commercially available and widely used.

In general, a lithium secondary battery includes a lithium transition metal oxide as a positive active material and a lithium metal, a carbonaceous material, a silicon-based material, or a tin-based material as a negative active material.

Carbonaceous materials were first introduced by Japanese Sony Energy Tec Inc. in the early 1990s, and thereafter, has often been used as a negative active material for lithium secondary batteries. Currently, the theoretical capacity of 350 mAh/g for carbonaceous materials is being realized.

Recently, much research into silicon-based negative active materials has been performed, since silicon, or alloys of silicon, cobalt, nickel, or iron, may allow large amounts of lithium to reversibly intercalate and deintercalate through a compound formation reaction with lithium. Also, silicon-based negative active materials have a theoretical maximum capacity of about 4,200 mAh/g, which is ten times greater than that of carbonaceous materials. Thus, silicon-based negative active materials are high-capacity negative electrode materials that can be used as alternatives to carbonaceous materials.

Tin-based negative active materials have a theoretical electric capacity of 990 mAh/g, which is 2.7 times greater than that of graphite. Thus, tin-based negative active materials are also used as alternatives to graphite, together with silicon-based active materials.

However, during charging and discharging, silicon-based negative active materials and tin-based negative active materials undergo volumetric changes, increasing in volume by a factor of as much as 200 to 300 when they react with lithium. Due to such large volumetric changes, if charging and discharging continues, the negative active materials separate from the current collector, or electrical contact may be lost due to pulverization of the negative active material particles. Also, since the negative active materials have an irreversible discharge capacity of about 50% of the initial capacity, if charging and discharging continues, capacity rapidly decreases and cycle lifetime is reduced.

Accordingly, there is a need to develop a negative active material composition that prevents interior stress from occurring during volumetric expansion, and thereby preventing separation of the active material from the current collector resulting from such volumetric changes during charging and discharging.

### SUMMARY

One or more embodiments of the present invention include a negative active material composition for preventing interior stress occurring during volumetric expansion by forming pores in an electrode plate.

One or more embodiments of the present invention include a method of preparing a negative electrode plate using the negative active material composition.

One or more embodiments of the present invention include a lithium secondary battery having good lifetime characteristics manufactured using the negative active material composition.

According to embodiments of the present invention, a negative active material composition includes a negative active material, a binder, and a solvent, in which the solvent may include an aqueous solvent and an organic solvent.

According to other embodiments of the present invention, a method of preparing a negative electrode plate includes mixing a negative active material, a binder, and a solvent to prepare a negative active material composition; coating the negative active material composition on an electrode support; drying the negative active material composition to form a dried film; and after the dried film is formed, pressing the resultant structure to form a negative electrode plate including a negative active material layer. The solvent includes an aqueous solvent and an organic solvent.

According to still other embodiments of the present invention, a lithium secondary battery includes a negative electrode including a current collector and a negative active material layer formed on the current collector, a positive electrode, and an electrolytic solution. The mixed density of the negative active material layer is about 1.0 g/cc to about 1.5 g/cc.

The negative active material layer may have a BET specific surface area of about 0.05 m²/g to about 0.60 m²/g.

A negative electrode may be manufactured using the negative active material composition.

Negative active material compositions and methods of preparing negative electrode plates using the negative active material compositions according to embodiments of the present invention enable the formation of pores in the electrode plate so as to prevent interior stress from occurring during volumetric expansion. Thus, lithium secondary batteries manufactured using the negative active material compositions have good lifetime characteristics.

### BRIEF DESCRIPTION OF THE DRAWINGS

FIG. 1 is a graph comparing the thickness of the dried films prepared according to Examples 1 to 4 and Comparative Example 1.

FIG. 2 is a graph comparing the BET specific surface area of the negative active material layers of the anode plates prepared according to Examples 1 to 4 and Comparative Example 1.

FIG. 3 is a graph comparing the lifetime characteristics of the half cells including anode plates prepared according to Examples 1 to 4 and Comparative Example 1.

FIG. 4 is a cross-sectional perspective view of a lithium secondary battery according to an embodiment of the present invention.

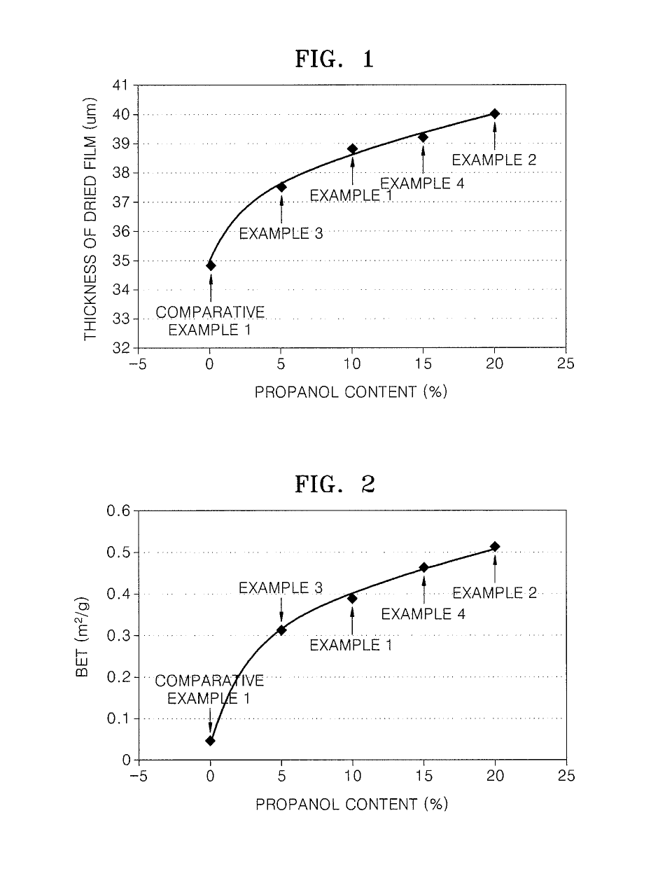

### DETAILED DESCRIPTION

Hereinafter, certain embodiments of a negative active material composition, a method of preparing a negative electrode plate using the negative active material composition, and a lithium secondary battery manufactured using the negative active material composition will be described. However, the embodiments are exemplary and the present invention is not limited thereto.

A negative active material composition according to an embodiment of the present invention includes a negative active material, a binder, and a solvent, in which the solvent may include an aqueous solvent and an organic solvent. The term “aqueous solvent,” as used herein, refers to a solvent that includes water, and the term “organic solvent,” as used herein, refers to a solvent that does not include water.

The organic solvent may include methanol, ethanol, propanol, isopropanol, acetone, dimethylformamide, dimethylacetamide, chloroform, dichloromethane, trichloroethylene, normalhexane, or a mixture thereof. For example, the organic solvent may be methanol, ethanol, propanol, isopropanol, or acetone. For example, the organic solvent may be propanol.

The organic solvent may be soluble with respect to the aqueous solvent, so that the negative active material composition may be easily prepared. For example, if the organic solvent is propanol (having a boiling point of 97° C., which is close to the boiling point of the aqueous solvent , i.e., 100° C.), the organic solvent is highly soluble with respect to the aqueous solvent, and is therefore easily mixed with the aqueous solvent. Thus, the negative active material composition can be more easily formed.

The solvent may prevent interior stress from occurring during volumetric expansion of the negative active material during charging and discharging by forming pores in the electrode plate. Also, the porosity of the electrode plate may vary according to the amount of the organic solvent in the negative active material composition. In addition, the porosity of the electrode plate is dependent upon the solubility of the binder with respect to the aqueous solvent and the organic solvent, and the volatility of the aqueous solvent and the organic solvent.

An amount of the negative active material may be about 30 to about 70 wt %, for example, about 45 to about 55 wt %, based on the total weight of the negative active material composition. An amount of the binder may be about 2 to about 30 wt % based on the total weight of the negative active material composition. If the amounts of the negative active material and the binder are within these ranges, the electrode plate prepared using the negative active material has good lifetime characteristics, high electrode plate binding strength, and high flexibility, and a battery manufactured using the negative active material has high-capacity characteristics.

An amount of the solvent may be about 30 to about 70 wt %, for example about 35 to about 50 wt %, based on the total weight of the negative active material composition. If the amount of the solvent is within these ranges, the negative active material composition is appropriate for coating, and maintains an appropriate viscosity, thereby preparing a negative active material composition having good conservation characteristics.

Also, the aqueous solvent and the organic solvent may be mixed in a weight ratio of about 9:1 to about 1:9. For example, the mixed weight ratio of the aqueous solvent to the organic solvent may be about 5:1 to about 3:2. For example, the mixed weight ratio of the aqueous solvent to the organic solvent may be about 4:1 to about 3:2.

The mixed weight ratio of the aqueous solvent to the organic solvent may vary according to the compatibility of the aqueous solvent, the organic solvent, and the binder. For example, if the mixed weight ratio of the aqueous solvent to the organic solvent is within the ranges described above, the binder may easily dissolve in the aqueous solvent and the organic solvent, and the electrode plate has high porosity and thus, battery performance, for example, lifetime characteristics, may be improved.

The negative active material may include at least one material selected from lithium metal, a metal material that is alloyable with lithium, a material that dopes and dedopes lithium, a material that reversibly reacts with lithium to form a lithium-containing compound, a transition metal oxide, a carbonaceous material, and a composite material including a metal material and a carbonaceous material.

Nonlimiting examples of the metal material that is alloyable with lithium include Al, Si, Sn, Pb, Zn, Bi, In, Mg, Ga, Cd, Ag, Ge, K, Na, Ca, Sr, Ba, Sb, Zn, and Ti. The metal material may be any one of various materials that are used in the art.

Nonlimiting examples of materials that dope and dedope lithium, materials that reversibly react with lithium to form lithium-containing compounds, and transition metal oxides include tin oxides, vanadium oxides, lithium vanadium oxides, titianium nitrates, Si, SiOₓ (where 0<x<1), Sn, and Sn alloy composites. In some embodiments, examples of materials that dope and dedope lithium, materials that reversibly react with lithium to form lithium-containing compounds, and transition metal oxides include tin oxides, Si, SiOₓ (where 0<x<1), Sn, and Sn alloy composites. In some embodiments, examples of materials that dope and dedope lithium, materials that reversibly react with lithium to form lithium-containing compounds, and transition metal oxides include SiOₓ (where 0<x<1). However, the materials that dope and dedope lithium, materials that reversibly react with lithium to form lithium-containing compounds, and transition metal oxides are not limited thereto, and may be any one of various materials that are used in the art.

The carbonaceous material may be amorphous carbon or crystalline carbon. Nonlimiting examples of amorphous carbon include soft carbon (e.g., low-temperature calcined carbon), hard carbon, meso-phase pitch carbide, and calcined coke. Nonlimiting examples of crystalline carbon include natural graphite and artificial graphite, each of which has an amorphous shape, a plate shape, a flake shape, a spherical shape, or a fiber shape. However, the carbonaceous material is not limited thereto and may be any one of various materials that are used in the art.

The binder may facilitate attachment of negative active material particles to each other and to the current collector. The binder may include at least one material selected from carboxymethylcellulose (CMC), styrene-butadiene rubber (SBR), polyacrylicacid (PAA), polyvinylalcohol (PVA), hydroxypropylenecellulose, diacetylenecellulose, polyvinylchloride, polyvinylpyrrolidone, polytetrafluoroethylene, polyvinylidene fluoride, polyethylene, and polypropylene. For example, the binder may be a water-based binder. For example, the water-based binder may be selected from carboxymethylcellulose (CMC), hydroxypropylenecellulose, diacetylenecellulose, styrene-butadiene rubber (SBR), polyacrylicacid (PAA), or polyvinylalcohol (PVA). For example, the binder may be polyacrylicacid (PAA). However, the binder is not limited thereto and may be any one of various materials that are soluble with respect to the aqueous solvent and the organic solvent.

Also, the negative active material composition may further include a conductive agent. The conductive agent provides conductivity to the electrode and may be any one of various materials that do not cause any chemical change in the electrode. The conductive agent may include at least one material selected from carbon black, ketjen black, acetylene black, artificial graphite, natural graphite, copper powder, nickel powder, aluminum powder, silver powder, and polyphenylene, but is not limited thereto. An amount of the conductive agent may be, for example, about 1 to about 3 wt %, but is not limited thereto, and may be used in any amount used in conventional lithium secondary batteries.

A method of preparing a negative electrode plate according to an embodiment of the present invention includes mixing a negative active material, a binder, and a solvent to prepare a negative active material composition; coating the negative active material composition on an electrode support; drying the negative active material composition to form a dried film; and after the dried film is formed, pressing the resultant structure to form a negative electrode plate including a negative active material layer. The solvent includes an aqueous solvent and an organic solvent.

The negative active material composition may further include a conductive agent. The negative active material, the binder, and the conductive agent are the same as described above.

In coating the negative active material composition on the electrode support, the electrode support may be a current collector, and the coating may include spray coating or doctor blade coating, but is not limited thereto, and may be any one of various coating methods that are used in the art.

In forming the dried film by drying the negative active material composition, the thickness of the dried film may be about 30 μm to about 40 μm. For example, the thickness of the dried film may be about 32 μm to about 40 μm. For example, the thickness of the dried film may be about 34 μm to about 40 μm.

The drying temperature may be about 80° C. to about 130° C. For example, the drying temperature may be about 100° C. to about 130° C. For example, the drying temperature may be about 110° C. to about 130° C. The drying time may be about 5 minutes to about 30 minutes. For example, the drying time may be about 5 minutes to about 15 minutes.

Besides different solubilities with respect to the binder, the aqueous solvent and the organic solvent have different vapor pressures. For example, the organic solvent is dissolved prior to the aqueous solvent, and during drying, the organic solvent evaporates prior to the aqueous solvent, thereby forming pores (i.e., empty spaces) in the electrode plate. The dried film having a thickness within the above ranges may be formed by controlling the amount of the organic solvent used.

In pressing the resultant structure to form the negative electrode plate including the negative active material layer after the dried film is formed, the mixed density of the negative active material layer may be, for example, about 1.10 g/cc to about 1.30 g/cc. For example, the mixed density of the negative active material layer may be about 1.10 g/cc to about 1.20 g/cc.

For example, if the mixed density of the negative active material layer is 1.13 g/cc, the negative active material layer may have a BET specific surface area of about 0.05 m²/g to about 0.60 m²/g, for example, about 0.3 m²/g to about 0.60 m²/g, or for example, about 0.05 m²/g to about 0.55 m²/g.

If the BET specific surface area is within the ranges described above, the negative electrode plate has pores and thus, stress on the negative electrode plate applied due to volumetric expansion of the negative active material during charging and discharging may be prevented, and battery lifetime characteristics may be improved.

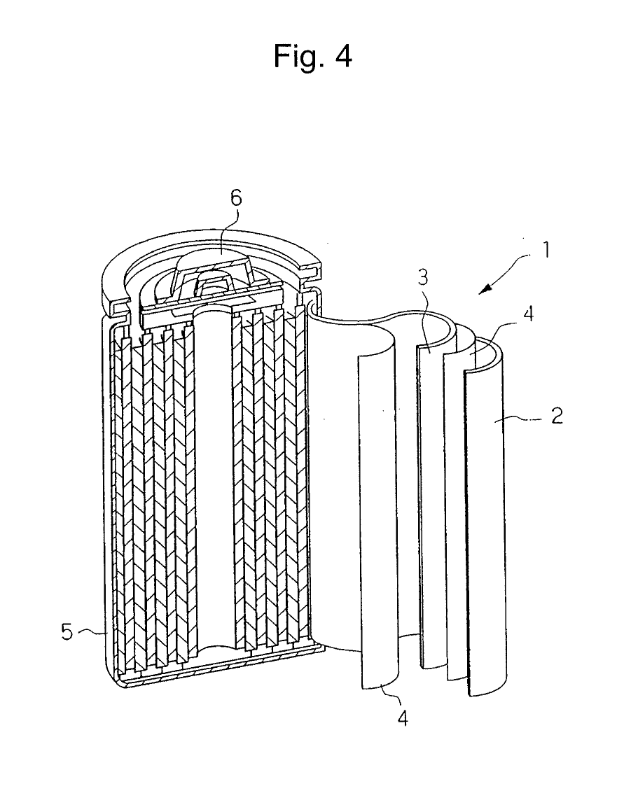

A lithium secondary battery according to an embodiment of the present invention is shown in FIG. 4. As shown in FIG. 4, the lithium battery 1 comprises an anode 2, a cathode 3 and a separator 4 positioned between the anode 2 and cathode 3. The anode 2, cathode 3 and separator 4 are wound together to form an electrode assembly. The electrode assembly is enclosed within a battery case 5 with an electrolyte, and is sealed with a cap assembly 6. The negative electrode 2 includes a current collector and a negative active material layer formed on the current collector.

The mixed density of the negative active material layer is about 1.0 g/cc to 1.5 g/cc. For example, the mixed density of the negative active material layer is about 1.10 g/cc to about 1.30 g/cc. For example, a mixed density of the negative active material layer is about 1.10 g/cc to about 1.20 g/cc.

The negative electrode includes the current collector and the negative active material layer formed on the current collector. The negative active material layer may have a mixed density of, for example, about 1.13 g/cc, and a BET specific surface area of about 0.05 m²/g to about 0.60 m²/g, for example about 0.3 m²/g to about 0.60 m²/g, or for example, about 0.04 m²/g to about 0.55 m²/g.

If the BET specific surface area of the negative active material layer is within the ranges described above, an electrode plate having good high-rate characteristics and high porosity is formed, and thus, a lithium secondary battery having good lifetime characteristics may be provided. The electrode plate having good high-rate characteristics and high porosity substantially prevents stress on the electrode plate resulting from volumetric expansion of the negative active material during charging and discharging.

The current collector may be formed of Al, Cu, etc., but the material for the current collector is not limited thereto. Also, the negative electrode may be manufactured using the negative active material composition.

The positive electrode may include a current collector and a positive active material layer. The current collector for the positive electrode may be formed of Al, but the material for forming the current collector for the positive electrode is not limited thereto.

The positive active material layer may include a positive active material, a binder, and optionally, a conductive agent. The positive active material may include a compound that reversibly intercalates and deintercalates lithium (i.e., a lithiated intercalation compound). Nonlimiting examples of such compounds include compounds represented by the following formulae.

LiₐA_{1-b}X_{b}D₂ (0.95≦a 1.1, 0≦b≦5 0.5)

LiₐE_{1-b}X_{b}O_{2-c}D_{c} (0.95≦a≦1.1, 0≦b≦0.5, 0≦c≦0.05)

LiE_{2-b}X_{b}O_{4-c}D_{c} (0≦b≦0.5, 0≦c≦0.05)

LiₐNi_{1-b-c}Co_{b}B_{c}D_{α} (0.95≦a≦1.1, 0≦b≦0.5, 0≦c≦0.05, 0<α≦2)

LiₐNi_{1-b-c}Co_{b}X_{c}O_{2-α}M_{α} (0.95≦a≦1.1, 0≦b≦0.5, 0≦c≦0.05, 0<α<2)

LiₐNi_{1-b-c}Co_{b}X_{c}O_{2-α}M₂ (0.95≦a≦1.1, 0≦b≦0.5, 0≦c≦0.05, 0<α<2)

LiₐNi_{1-b-c}Mn_{b}X_{c}D_{α} (0.95≦a≦1.1, 0≦b≦0.5, 0≦c≦0.05, 0<α≦2)

LiₐNi_{1-b-c}Mn_{b}X_{c}O_{2-α}M_{α} (0.95≦a≦1.1, 0≦b≦0.5, 0≦c≦0.05, 0<α<2)

LiₐNi_{1-b-c}Mn_{b}X_{c}O_{2-α}M₂ (0.95≦a≦1.1, 0≦b≦0.5, 0≦c≦0.05, 0<α<2)

LiₐNi_{b}E_{c}G_{d}O₂ (0.90≦a≦1.1, 0≦b≦0.9, 0≦c≦0.5, 0.001≦d≦0.1)

LiₐNi_{b}Co_{c}Mn_{d}GeO₂ (0.90≦a≦1.1, 0≦b≦0.9, 0≦c≦0.5, 0≦d≦0.5, 0≦e≦0.1)

LiₐNiG_{b}O₂ (0.90≦a≦1.1, 0.001≦b≦0.1)

LiₐCoG_{b}O₂ (0.90≦a≦1.1, 0.001≦b≦0.1)

LiₐMnG_{b}O₂ (0.90≦a≦1.1, 0.001≦b≦0.1)

LiₐMn₂G_{b}O₄ (0.90≦a≦1.1, 0≦b≦0.1)

QO₂

QS₂

LiQS₂

V₂O₅

LiV₂O₅

LiZO₂

LiNiVO₄

Li_{(3-f)}J₂(PO₄)₃(0≦f≦2)

Li_{(3-f)}Fe₂(PO₄)₃(0≦f≦2)

LiFePO₄

lithium titanate.

In the formulas above, A is selected from Ni, Co, Mn, and combinations thereof, but is not limited thereto. X is selected from Al, Ni, Co, Mn, Cr, Fe, Mg, Sr, V, rare-earth elements, and combinations thereof, but is not limited thereto. D is selected from O, F, S, P, and combinations thereof, but is not limited thereto. E is selected from Co, Mn, and combinations thereof, but is not limited thereto. M is selected from F, S, P, and combinations thereof, but is not limited thereto. G is selected from Al, Cr, Mn, Fe, Mg, La, Ce, Sr, V, and combinations thereof, but is not limited thereto. Q is selected from Ti, Mo, Mn, and combinations thereof, but is not limited thereto. Z is selected from Cr, V, Fe, Sc, Y, and combinations thereof, but is not limited thereto. J is selected from V, Cr, Mn, Co, Ni, Cu, and combinations thereof, but is not limited thereto.

Nonlimiting examples of the positive active material include LiMn₂O₄, LiNi₂O₄, LiCoO₂, LiNiO₂, LiMnO₂, Li₂MnO₃, LiFePO₄, and LiNiₓCo_{y}O₂(0<x≦0.15, and 0<y≦0.85).

The binder facilitates attachment of the positive active material particles to each other and to the current collector. Nonlimiting examples of the binder include polyvinylalcohol, carboxymethylcellulose, hydroxypropylcellulose, diacetylcellulose, polyvinylchloride, carboxylated polyvinylchloride, polyvinylfluoride, ethylene oxide-containing polymers, polyvinylpyrrolidone, polyurethane, polytetrafluoroethylene, polyvinylidene fluoride, polyethylene, polypropylene, styrene-butadiene rubber, acrylated styrene-butadiene rubber, epoxy resin, and nylon.

The conductive agent provides conductivity to the positive electrode, and may be any one of various materials that do not cause any chemical change in the positive electrode and are electronically conductive. Nonlimiting examples of the conductive agent include natural graphite, artificial graphite, carbon black, acetylene black, ketjen black, carbon fiber, and metal powders or fibers of copper, nickel, aluminum, or silver. Also, the conductive agent may be at least one polyphenylene derivative.

Amounts of the positive active material, the binder, and the conductive agent may be used at the same levels as conventionally used in lithium secondary batteries. For example, a weight ratio of the positive active material to the sum of the conductive agent and the binder may be about 98:2 to about 92:8, and a mixed ratio of the conductive agent to the binder may be about 1:1.5 to 3. However, the ratios are not limited thereto.

In order to form the positive active material layer, a positive active material and a binder (and optionally, a conductive agent) may be mixed in a solvent to prepare a composition for forming a positive active material layer, and then the composition is coated on a current collector. This method of manufacturing the positive electrode is known in the art.

Nonlimiting examples of the solvent include chain carbonates (such as dimethyl carbonate, ethylmethyl carbonate, diethyl carbonate, and dipropyl carbonate), cyclic carbonates (such as dimethoxyethane, diethoxyethane, fatty acid ester derivatives, ethylene carbonate, propylene carbonate, and butylene carbonate), γ-butyrolactone, N-methylpyrrolidone, acetone, and water.

The composition for forming the positive active material layer and the composition for forming the negative active material layer may further include a plasticizer to form pores in the negative active material layer.

The electrolytic solution may include a non-aqueous organic solvent and a lithium salt. The non-aqueous organic solvent may act as a medium through which ions participating in the electrochemical reaction of the battery migrate.

Nonlimiting examples of the non-aqueous organic solvent include carbonate-based solvents, ester-based solvents, ether-based solvents, ketone-based solvents, alcohol-based solvents, and non-protonic solvents. Nonlimiting examples of carbonate-based solvents include dimethyl carbonate(DMC), diethyl carbonate(DEC), dipropyl carbonate(DPC), methylpropyl carbonate(MPC), ethylpropyl carbonate(EPC), ethylmethyl carbonate(EMC), ethylene carbonate(EC), propylene carbonate(PC), butylene carbonate(BC), and ethylmethyl carbonate(EMC). Nonlimiting examples of ester-based solvents include methyl acetate, ethyl acetate, n-propyl acetate, dimethyl acetate, methyl propionate, ethyl propionate, γ-butyrolactone, decanolide, valerolactone, mevalonolactone, and caprolactone. Nonlimiting examples of ether-based solvents include dibutyl ether, tetraglyme, diglyme, dimethoxyethane, 2-methyl tetrahydrofuran, and tetrahydrofuran. A nonlimiting example of a ketone-based solvent is cyclohexanone. Nonlimiting examples of alcohol-based solvents include ethyl alcohol and isopropyl alcohol. Nonlimiting examples of non-protonic solvents include nitriles represented by R—CN (where R is a linear, branched, or cyclic hydrocarbonyl group having from 2 to 20 carbon atoms, and where R may have a double bond, aromatic ring, or an ether bond), amides (such as dimethyl formamide), dioxolanes (such as 1,3-dioxolane), and sulfolanes.

A single non-aqueous organic solvent may be used, or a combination of solvents may be used. If the non-aqueous organic solvent includes a combination of solvents, a mixture ratio may be adjusted according to the desired performance of the battery.

The lithium salt may be dissolved in an organic solvent and used as a source for lithium ions in the lithium secondary battery, thereby enabling the basic operation of the lithium secondary battery and promoting the flow of lithium ions between the positive electrode and the negative electrode. The lithium salt may include at least one supporting electrolytic salt selected from LiPF₆, LiBF₄, LiSbF₆, LiAsF₆, LiN(SO₂C₂F₅)₂, Li(CF₃SO₂)₂N, LiC₄F₉SO₃, LiClO₄, LiAlO₂, LiAlCl₄, LiN(CₓF₂ₓ₊₁SO₂)(C_{y}F_{2y+1}SO₂) (where x and y are natural numbers), LiCl, LiI, and LiB(C₂O₄)₂ (lithium bis(oxalato) borate or LiBOB). A concentration of the lithium salt may be about 0.1 to about 2.0 M. If the concentration of the lithium salt is within this range, the electrolytic solution has an appropriate conductivity and viscosity and thus, the electrolytic solution has good electrolytic performance, and lithium ions may effectively migrate through the electrolytic solution.

According to the type of lithium battery, a separator may be present between the positive electrode and the negative electrode. The separator may be a single- or multi-layer of polyethylene, polypropylene, or polyvinylidene fluoride. Alternatively, the separator may be a mixed multi-layer, such as a two-layer separator including polyethylene and polypropylene, a three-layer separator including polyethylene, polypropylene, and polyethylene, or a three-layer separator including polypropylene, polyethylene, and polypropylene.

Lithium secondary batteries can be classified as lithium ion batteries, lithium ion polymer batteries, and lithium polymer batteries, depending on the separator and electrolyte. Lithium secondary batteries can also be classified as cylindrical batteries, rectangular batteries, coin-type batteries, and pouch-type batteries, depending on the shape of the battery. Lithium secondary batteries can also be classified as bulky batteries and film-type batteries, depending on the size of the battery. The lithium battery according to an embodiment of the present invention may be used as a primary battery or a secondary battery. Methods of manufacturing the batteries are known in the art.

The following examples are presented for illustrative purposes only and are not intended to limit the scope of the present invention.

### EXAMPLES

### Preparation of Negative Active Material Composition

### Preparation Example 1

5 g of polyacrylicacid (PAA) was added to 40 g of water and 10 g of propanol and was completely dissolved by stirring to prepare a binder solution. 45 g of SiOₓ (0<x<1) active material was added to the binder solution to prepare a negative active material slurry composition.

### Preparation Example 2

A negative active material slurry composition was prepared as in Preparation Example 1, except that 30 g of water and 20 g of propanol were used.

### Preparation Example 3

A negative active material slurry composition was prepared as in Preparation Example 1, except that 45 g of water and 5 g of propanol were used.

### Preparation Example 4

A negative active material slurry composition was prepared as in Preparation Example 1, except that 35 g water of and 15 g of propanol were used.

### Preparation Example 5

A negative active material slurry composition was prepared as in Preparation Example 1, except that only 50 g of water was used.

### Preparation of Negative Electrode Plate

### Example 1

The negative active material slurry composition prepared according to Preparation Example 1 was coated to a thickness of 3.4 g/cm² on a Cu support, and then dried in an oven at a temperature of 110° C. for 5 minutes to form a dried film. A thickness of the dried film was 38.8 μm. After the dried film was formed, the resultant structure was pressed to manufacture a negative electrode plate having a thickness of 30 μm and a volumetric density (or mixed density) of 1.13 g/cc, in which a BET specific surface area of the negative active material layer was 0.3888 m²/g.

### Example 2

A negative electrode plate was prepared as in Example 1, except that the dried film was formed using the negative active material slurry composition prepared according to Preparation Example 3 and had a thickness of 40 μm, and the BET specific surface area of the negative active material layer was 0.5126 m²/g.

### Example 3

A negative electrode plate was prepared as in Example 1, except that the dried film was formed using the negative active material slurry composition prepared according to Preparation Example 4 and had a thickness of 37.5 μm, and the BET specific surface area of the negative active material layer was 0.3125 m²/g.

### Example 4

A negative electrode plate was prepared as in Example 1, except that the dried film was formed using the negative active material slurry composition prepared according to Preparation Example 2 and had a thickness of 39.2 μm, and the BET specific surface area of the negative active material layer was 0.4628 m²/g.

### Comparative Example 1

A negative electrode plate was prepared as in Example 1, except that the dried film was formed using the negative active material slurry composition prepared according to Preparation Example 5 and had a thickness of 34.8 μm, and the BET specific surface area of the negative active material layer was 0.048 m²/g.

### Electrode Plate Characteristics Evaluation and Lifetime Characteristics Evaluation

### Evaluation Example 1

### Electrode Plate Characteristics Evaluation

The thickness of the negative electrode dried film coated on the electrode plate before the electrode plate was pressed was obtained as follows. 10 portions of the electrode plate were randomly measured using a micrometer (from Mitsutoyo Inc.), and then the thickness of the support was deduced therefrom. The specific surface area of the negative active material layer after the electrode plate was pressed was measured using an Elzone II 5390 (manufactured by Micrometrics Instrument) according to the IS013319 Particle Size Analysis Electrical Sensing Zone Method. First, 50 mg of the negative electrode support used in each of Examples 1 through 4 and Comparative Example 1 was dried for 24 hours under a nitrogen atmosphere, and then the BET value thereof was measured and used as a base-line. 50 mg of the negative electrode support used in each of Examples 1 through 4 and Comparative Example 1 were used as samples, and the same measurement experiment was performed thereon.

The dried film thickness and BET specific surface area of the negative electrode plates prepared according to Examples 1 to 4 and Comparative Example 1 were measured and the results are shown in Table 1 below.

TABLE 1

| | Thickness of Dried Film (μm) | BET (m²/g) |
|---|---|---|
| Example 1 | 38.8 | 0.3888 |
| Example 2 | 40 | 0.5126 |
| Example 3 | 37.5 | 0.3125 |
| Example 4 | 39.2 | 0.4628 |
| Comparative | 34.8 | 0.048 |
| Example 1 | | |

Referring to Table 1, it was confirmed that when the negative active material slurry compositions were coated to the same thickness of 3.4 g/cm² on a Cu support and then dried to form dried films, the dried film thickness differed according to the organic solvent content in Examples 1 to 4 and Comparative Example 1.

Also, when the negative electrode plates were pressed such that the thickness thereof was 30 μm and the volumetric density (or mixed density) was 1.13 g/cc after the dried film was formed, the BET specific surface area of the negative active material layer differed according to the organic solvent content in Examples 1 to 4 and Comparative Example 1.

The results indicate that the negative electrode plates have pores.

### Evaluation Example 2

### Lifetime Characteristics Evaluation

Half-cells were manufactured using the negative electrode plates prepared according to Examples 1 through 4 and Comparative Example 1. The half-cells were charged with a constant current (0.02 C) at a constant voltage (0.01V, 0.01 C cut-off), and then discharged with a constant current (0.02 C) until the voltage reached 1.4 V. Then, the half-cells were charged with a constant current (0.5 C) at a constant voltage (0.01V, 0.01 C cut-off) and then discharged with a constant current (0.5 C) until the voltage reached 1.4 V. This charging and discharging process was performed 50 times.

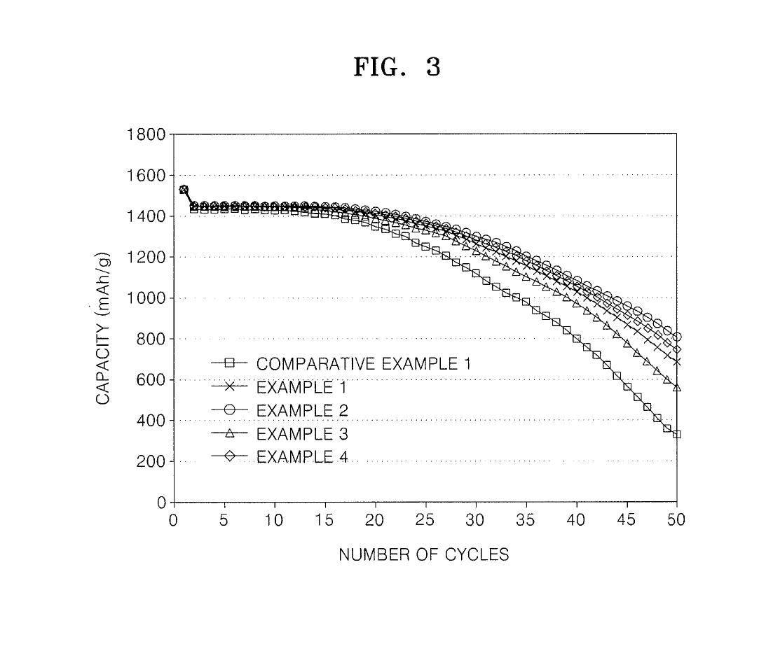

The results are shown in FIG. 3.

When the mixed density was the same, the capacity retention rate of the half-cells of Examples 1 through 4 was higher than that of the half-cell of Comparative Example 1. Thus, it was confirmed that the half-cells of Examples 1 through 4 had better lifetime characteristics than the half-cell of Comparative Example 1.

This is because the addition of an organic solvent leads to the formation of pores in the electrode plate, thereby substantially preventing the occurrence of stress in the electrode plate during volumetric expansion of the negative active material.

It is understood that while certain exemplary embodiments have been shown and described, the present invention is not limited to the described embodiments, which are to be considered in a descriptive sense only and not for purposes of limitation. Descriptions of features or aspects within each embodiment should typically be considered as available for other similar features or aspects in other embodiments. Indeed, those of ordinary skill in the art would recognize that certain modifications and changes can be made to the described embodiments without departing from the spirit and scope of the present invention, as defined in the attached claims.

What is claimed is:

1. A negative active material composition, comprising:
a negative active material;
a solvent comprising a mixture of an aqueous solvent and an organic solvent; and
a binder.

2. The negative active material composition according to claim 1, wherein the organic solvent is soluble in the aqueous solvent.

3. The negative active material composition according to claim 1, wherein the organic solvent is selected from the group consisting of methanol, ethanol, propanol, isopropanol, acetone, dimethylformamide, dimethylacetamide, chloroform, dichloromethane, trichloromethane, normal hexane, and mixtures thereof.

4. The negative active material composition according to claim 1, wherein the binder is present in the negative active material composition in an amount of about 2 to about 30 wt % based on a total weight of the negative active material composition.

5. The negative active material composition according to claim 1, wherein the solvent is present in the negative active material composition in an amount of about 30 to about 70 wt % based on a total weight of the negative active material composition.

6. The negative active material composition according to claim 1, wherein a weight ratio of the aqueous solvent to the organic solvent is about 9:1 to about 1:9.

7. The negative active material composition according to claim 1, wherein the binder comprises a water-based binder.

8. The negative active material composition according to claim 8, wherein the water-based binder is selected from the group consisting of carboxymethylcellulose (CMC), hydroxypropylenecellulose, diacetylenecellulose, styrene-butadiene rubber (SBR), polyacrylic acid (PAA), polyvinyl alcohol (PVA), and mixtures thereof.

9. A method of making a negative electrode plate, comprising:
applying a negative active material composition on an electrode support;
drying the negative active material composition to form a dried film; and
pressing the dried film to form a negative electrode plate comprising a negative active material layer.

10. The method according to claim 9, further comprising mixing a negative active material, a binder and a solvent to prepare the negative active material composition, wherein the solvent comprises a mixture of an aqueous solvent and an organic solvent.

11. The method according to claim 10, wherein the mixing the negative active material, binder and solvent comprises first mixing the binder and the solvent to form a mixture, and then adding the negative active material to the mixture.

12. The method according to claim 9, wherein the organic solvent is soluble in the aqueous solvent.

13. The method according to claim 9, wherein the organic solvent is selected from the group consisting of methanol, ethanol, propanol, isopropanol, acetone, dimethylformamide, dimethylacetamide, chloroform, dichloromethane, trichloromethane, normal hexane, and mixtures thereof.

14. The method according to claim 9, wherein the binder comprises a water-based binder.

15. The method according to claim 14, wherein the water-based binder is selected from the group consisting of carboxymethylcellulose (CMC), hydroxypropylenecellulose, diacetylenecellulose, styrene-butadiene rubber (SBR), polyacrylic acid (PAA), polyvinyl alcohol (PVA), and mixtures thereof.

16. The method according to claim 9, wherein the dried film has a thickness of about 30 μm to about 40 μm.

17. The method according to claim 9, wherein the negative active material layer has a mixed density of about 1.0 g/cc to about 1.5 g/cc.

18. The method according to claim 9, wherein the negative active material layer has a BET specific surface area of about 0.05 m²/g to about 0.60 m²/g.

19. A lithium battery, comprising:
a positive electrode comprising a positive active material layer;
a negative electrode comprising a negative active material layer having a mixed density of about 1.0 g/cc to about 1.5 g/cc; and
an electrolyte.

20. The lithium battery of claim 19, wherein the negative active material layer has a BET specific surface area of about 0.05 m²/g to about 0.60 m²/g.
